(19) United States
(12) Patent Application Publication
(10) Pub. No.: US 2025/0300380 A1
(43) Pub. Date: Sep. 25, 2025

(54) HYBRID FLOATING ELECTRICAL CONNECTOR AND ELECTRONIC SYSTEM THEREOF

(71) Applicant: Amphenol Commercial Products (Chengdu) Co., Ltd., Chengdu (CN)

(72) Inventors: Xingrui Yang, Chengdu (CN); Chao Zou, Chengdu (CN)

(73) Assignee: Amphenol Commercial Products (Chengdu) Co., Ltd., Chengdu (CN)

(21) Appl. No.: 19/083,904

(22) Filed: Mar. 19, 2025

(30) Foreign Application Priority Data
Mar. 22, 2024 (CN) 202410333915.8
Mar. 22, 2024 (CN) 202420567161.8

(51) Int. Cl. H01R 12/91

(52) U.S. Cl. CPC H01R 12/91

(57) ABSTRACT

Hybrid floating electrical connectors and electronic systems thereof. A floating electrical connector includes a housing comprising first and second sides, and first and second interfaces at the first and second sides of the housing respectively. Each of the first and second interfaces comprises conductive elements rigidly fixed to a respective support member, which is compliantly coupled to the housing. Each of the first and second interfaces can provide both signals and power. A flexible member is disposed in the housing and electrically connecting the first and second interfaces. For example, two printed circuit boards with mating contact pads may be connected by a flexible flat cable. The first and second interfaces can mate with board connectors mounted to different circuit boards, with the support members fixedly connected to board connector housings. Such a configuration can enable accurate and reliable interconnections between different circuit boards while providing increased tolerance of misalignments.

### CROSS-REFERENCE TO RELATED APPLICATIONS

This application claims priority to and the benefit of Chinese Patent Application No. 202420567161.8, filed on Mar. 22, 2024. This application also claims priority to and the benefit of Chinese Patent Application No. 202410333915.8, filed on Mar. 22, 2024. The contents of these applications are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

### SUMMARY

Aspects of the present disclosure relate to hybrid floating electrical connectors and electronic systems thereof.

Some embodiments relate to an electrical connector. The electrical connector may include a housing comprising a first side and a second side; a support member at least partially disposed in the housing and movably coupled to the housing; a first interface at the first side of the housing, the first interface comprising a plurality of first conductive elements fixed to the support member; a second interface at the second side of the housing, the second interface comprising a plurality of second conductive elements; and a flexible member disposed in the housing and electrically connecting respective first conductive elements of the first interface with respective second conductive elements of the second interface.

Optionally, the electrical connector may comprise an elastic member disposed between the support member and the housing.

Optionally, the support member is a first support member; the electrical connector comprises a second support member at least partially disposed in the housing and compliantly coupled to the housing; and the plurality of second conductive elements are rigidly fixed to the second support member.

Optionally, the elastic member is a first elastic member; and the electrical connector comprises a second elastic member disposed between the second support member and the housing.

Optionally, the first support member comprises first and second holes extending through the first support member; the second support member comprises third and fourth holes extending through the second support member; the first hole is aligned with the third hole in a mating direction of the electrical connector; and the second hole is aligned with the fourth hole in the mating direction.

Optionally, the first support member comprises a first body portion disposed in the housing and a first annular groove; the first elastic member is disposed in the first annular groove; the second support member comprises a second body portion disposed in the housing and having a second annular groove; and the second elastic member is disposed in the second annular groove.

Optionally, each of the first support member and the second support member comprises a hook engaging an outer surface of the housing.

Optionally, the hook comprises a U-shaped cross-section that opens toward the flexible member.

Optionally, the first interface is disposed between the first hole and the second hole of the first support member; and the second interface is disposed between the third hole and fourth hole of the second support member.

Optionally, the housing comprises a first chamber and a second chamber; the first support member is disposed in the first chamber; and the second support member is disposed in the second chamber and spaced from the first chamber in the mating direction.

Optionally, the first interface comprises a printed circuit board; and the printed circuit board comprises a first terminal portion having one or more power contact pads, and a second terminal portion spaced from the first terminal portion and having one or more signal contact pads.

Optionally, the elastic member comprises a silicone rubber gasket.

Optionally, the flexible member comprises a cable connected to both the first interface and the second interface.

Optionally, the cable is a flexible flat cable.

Some embodiments relate to an electrical connector. The electrical connector may include a terminal assembly comprising a plurality of terminal groups and an assembly housing holding the plurality of terminal groups; and a housing comprising a plurality of channels for receiving the plurality of terminal groups of the terminal assembly, a mounting end configured to mount to a circuit board, a mating end, a slot having a socket at the mating end, and a projection protruding in a second direction perpendicular to a mating direction of the connector and comprising an aperture extending through the projection, the aperture configured to receive a connecting member for securing the connector to the circuit board.

Optionally, the plurality of terminal groups are disposed side by side in the second direction and spaced apart from each other; each of the plurality of terminal groups comprises a pair of first conductive elements facing each other in a third direction perpendicular to both the mating direction and the second direction, and a pair of second conductive elements facing each other in the third direction; and the first conductive elements is longer than the second conductive element in the mating direction.

Optionally, the projection is a first projection protruding from a first side of the housing; the housing comprises a second projection protruding from a second side of the housing and comprising an aperture extending through the second projection; and each of the first projection and the second projection is shorter than the first conductive elements in the mating direction.

Some embodiments relate to an electronic system. The electronic system may include a circuit board; a first electrical connector mounted to the circuit board, the first electrical connector comprising a first housing having a slot at a mating end facing away from the circuit board; and a second electrical connector comprising a support member fixedly connected to the first housing of the first electrical connector, a mating interface rigidly fixed to the support member and disposed in the slot of the first housing of the first electrical connector, and a second housing holding the support member and compliantly coupled to the support member such that the second housing is movable with respect to the first housing of the first electrical connector.

Optionally, the support member of the second electrical connector is a first support member; the mating interface of the second electrical connector is a first mating interface; and the second electrical connector comprises a second mating interface, and a flexible member disposed in the second housing and electrically connecting respective conductive elements of the first electrical connector with respective second conductive elements of the second interface of the second electrical connector.

Optionally, the circuit board is a first circuit board; the electronic system comprises a second circuit board, and a third electrical connector mounted to the second circuit board, the third electrical connector comprising a third housing fixedly connected to the second support member of the second electrical connector; the second interface of the second electrical connector is disposed in the third housing of the third electrical connector; and the second electrical connector comprises a second support member compliantly coupled to the second housing of the second electrical connector such that the second housing of the second electrical connector is movably with respect to the third housing of the third electrical connector.

Some embodiments relate to an electrical connector. The electrical connector may have a length extending along a first direction; a width extending along a second direction perpendicular to the first direction; and a thickness extending along a third direction perpendicular to both the first direction and the second direction. The electrical connector may comprise: a first housing, the first housing having a first side and a second side opposite to the first side in the first direction of the first housing; a first interface at least partially disposed in the first housing, the first interface comprising first conductive elements and extending beyond the first side in the first direction; a first support member at least partially disposed in the first housing and positioned close to the first side, the first interface configured to be fixedly connected to the first support member; a first elastic member disposed between an outer surface of the first support member and an inner surface of the first housing, the first elastic member configured to be deformable to allow the first support member to be deflected with respect to the first housing in at least one of the second direction and the third direction; a second interface at least partially disposed in the first housing, the second interface comprising second conductive elements and extending beyond the second side in the first direction; and a flexible member disposed between the first interface and the second interface and electrically connecting the first conductive elements of the first interface with the second conductive elements of the second interface.

Optionally, the electrical connector further may comprise: a second support member at least partially disposed in the first housing and positioned adjacent to the second side, the second interface configured to be fixedly connected to the second support member; and a second elastic member disposed between an outer surface of the second support member and an inner surface of the first housing. The second elastic member may be deformable to allow the second support member to be deflected with respect to the first housing in at least one of the second direction and the third direction.

Optionally, the first support member may comprise a hole extending through the first support member along the first direction. The second support member may comprise a hole extending through the second support member along the first direction.

Optionally, the first support member may comprise a first hole and a second hole which are configured to be symmetrical about a first central axis of the electrical connector. The second support member may comprise a third hole and a fourth hole which are configured to be symmetrical about the first center axis of the electrical connector. The first hole is aligned with the third hole in the first direction of the electrical connector; and the second hole is aligned with the fourth hole in the first direction of the electrical connector.

Optionally, the first support member may comprise a first body portion disposed in the first housing. The first body portion may comprise a first annular groove on an outer peripheral surface of the first body portion, and the first elastic member is disposed in the first annular groove. The second support member may comprise a second body portion disposed in the first housing. The second body portion may comprise a second annular groove on an outer peripheral surface of the second body portion, and the second elastic member is disposed in the second annular groove.

Optionally, each of the first support member and the second support member may comprise an engagement portion that is engaged with an outer surface of the first housing to limit movement of the first housing in the first direction.

Optionally, the first support member may be formed as a profiled member. The first support member may comprise a first inner surface adjacent to the flexible member and a first outer surface opposite to the first inner surface in the first direction. The first support member may comprise a first engagement portion and a second engagement portion which are disposed on two opposite lateral edges of the first outer surface in the third direction. The first housing may comprise a first housing side surface and a second housing side surface opposite to the first housing side surface in the third direction. The first housing side surface may comprise a first recess and a second recess, and the second housing side surface may comprise a third recess and a fourth recess. The first engagement portion is engaged with the first recess of the first housing side surface; and the second engagement portion is engaged with the third recess of the second housing side surface.

Optionally, the second support member is formed as a profiled member, and the second support member may comprise a second inner surface adjacent to the flexible member and a second outer surface opposite to the second inner surface in the first direction. The second support member may comprise a third engagement portion and a fourth engagement portion which are disposed on two opposite lateral edges of the second outer surface in the third direction. The third engagement portion is engaged with the second recess of the first housing side surface; and the fourth engagement portion is engaged with the fourth recess of the second housing side surface.

Optionally, each of the first engagement portion, the second engagement portion, the third engagement portion and the fourth engagement portion has a U-shaped cross-section perpendicular to the second direction. An opening portion of the U-shape is configured to face the flexible member.

Optionally, the first interface is disposed in the second direction between the first hole and the second hole; and the second interface is disposed in the second direction between the third hole and fourth hole.

Optionally, the first housing may comprise a first chamber and a second chamber disposed on an inner periphery surface of the first housing, the first support member is disposed in the first chamber, and the second support member is disposed in the second chamber, The first chamber and the second chamber are each formed to have a concave shape and are spaced apart from each other in the first direction of the electrical connector.

Optionally, each of the first interface and the second interface may be configured as a printed circuit board, and may comprise a first terminal portion having one or more power contact pads, and a second terminal portion having one or more signal contact pads. The first terminal portion and the second terminal portion are spaced apart from each other in the second direction.

Optionally, at least one of the first elastic member and the second elastic member may comprise a silicone rubber gasket.

Optionally, the flexible member may comprise a flexible flat cable connected to the first interface and the second interface by soldering.

Some embodiments relate to a board connector. The board connector may have a height extending along a first direction, a width extending along a second direction perpendicular to the first direction, and a thickness extending along a third direction perpendicular to both the first direction and the second direction. The board connector may comprise: a terminal assembly comprising a plurality of terminal groups and an assembly housing that holds the plurality of terminal groups and is molded over the plurality of terminal groups; and a second housing comprising a plurality of channels for receiving the terminal assembly. The second housing may comprise a mounting end to be mounted with a circuit board and a mating end opposite to the mounting end. The second housing may comprise a slot, and a socket (an inserting opening) of the slot is disposed at the mating end of the second housing. The plurality of terminal groups may be disposed side by side in the second direction in a manner spaced apart from each other. Each of the plurality of terminal groups may comprise a pair of first conductive elements facing each other in the third direction, and a pair of second conductive elements facing each other in the third direction; a size of the first conductive element in the first direction may be greater than a size of the second conductive element in the first direction. A mating end of the first conductive element may be formed at the socket of the slot.

Optionally, four of the plurality of terminal groups are formed as power transmission terminals and the rest of the plurality of terminal groups are formed as signal transmission terminals.

Optionally, the second housing may comprise a first projection and a second projection disposed on two opposite sides of the second housing in the second direction. A size of each of the first projection and the second projection in the first direction is smaller than a size of the first conductive element in the first direction; and each of the first projection and the second projection comprises an aperture.

Optionally, each of the first conductive elements may comprise a first mating end adjacent to the socket, a first tail end opposite to the first mating end, and one or more curved portions disposed between the first mating end and the first tail end. The pair of first conductive elements may comprise a first contact portion and a second contact portion, which are adjacent to the first mating end and protruding towards a second central axis of the board connector. The first contact portion and the second contact portion are exposed in the slot. Each of the second conductive elements may comprise a second tail end flush with the first tail end of the first conductive element, a second mating end opposite to the second tail end, and one or more curved portions disposed between the second mating end and the second tail end. The pair of second conductive elements may comprise a third contact portion and a fourth contact portion, which are adjacent to the second mating end and protruding towards a second central axis of the board connector. The third contact portion and the fourth contact portion are exposed in the slot.

Optionally, the pair of the first conductive elements are mirrored about the second central axis of the board connector, and the pair of second conductive elements are mirrored about the second central axis of the board connector.

Optionally, a distance between the first contact portion of the first conductive element and the third contact portion of the second conductive element is in a range of 6 mm to 9 mm.

Optionally, the first tail end of each first conductive element extends through a mounting end of the second housing and has an L-shaped shape in a cross-section perpendicular to the second direction; and the second tail end of each second conductive element extends through the mounting end of the second housing and has a T-shaped shape in a cross-section perpendicular to the second direction.

Optionally, each of the second conductive elements may comprise a twist disposed between the second mating end and the second tail end. The twist connects a first belt portion and a second belt portion disposed at opposite ends of the twist such that a normal direction of a main surface of the first belt portion forms a twist angle in the range of 0 to 90 degrees with respect to a normal direction of a main surface of the second belt portion.

Optionally, each first conductive element may comprise a support arm and an elastic arm, which are disposed between the first mating end and the first tail end. The support arm is adjacent to the first tail end and connected to the elastic arm. Each of the first contact portion and the second contact portion is disposed on the elastic arm.

Optionally, the elastic arm may comprise a primary elastic arm and a secondary elastic arm. The primary elastic arm and the secondary elastic arm both extend from a position where the elastic arm is connected to the support arm in a direction away from the support arm. The primary elastic arm and the secondary elastic arm are spaced apart from each other. Each of the first contact portion and the second contact portion is disposed on a side of the primary elastic arm facing away from the secondary elastic arm.

Optionally, the primary elastic arm has a length greater than a length of the secondary elastic arm.

Some embodiments relate to an electronic system. The electronic system may comprise: a first circuit board; a first board connector described herein and connected to the first circuit board by a connecting member; and an electrical connector which is the electrical connector described herein and fitted to the first board connector such that the first interface of the electrical connector is inserted into a slot of the first board connector.

Optionally, the second housing of the first board connector may comprise a first projection and a second projection disposed on two opposite sides of the second housing in the second direction. Each of the first projection and the second projection in the first direction has a size smaller than a size of the first conductive element in the first direction. Each of the first projection and the second projection comprises an aperture. The first support member may comprise a hole extending through the first support member along the first direction.

Optionally, the connecting member may comprise a locking portion and a guiding portion connected to the locking portion. The guiding portion extends along the first direction, and the first board connector is fixedly connected to the first circuit board by the locking portion. The guiding portion extends through the aperture of the second housing and extends beyond the mating end of the second housing. The guiding portion is inserted into the hole of the first support member of the electrical connector, when the electrical connector is fitted to the first board connector.

Optionally, the locking portion may comprise a first portion connected to the guiding portion and a second portion having a diameter smaller than a diameter of the first portion. A first stop surface is formed at a connection surface where the first portion is connected with the second portion. The connecting member may comprise a second stop surface spaced apart from the first stop surface in the first direction. An end of the locking portion that is opposite to the guiding portion may comprise a hollow cavity having an inner threaded portion. The first circuit board is clamped between the first stop surface and the second stop surface when a screw is inserted into the hollow cavity and engaged with the inner threaded portion.

Optionally, the guiding portion is connected with the hole of the first support member of the electrical connector in a clearance fit manner, when the electrical connector is fitted to the first board connector.

Optionally, the first interface may comprise a first terminal portion having one or more power contact pads, and a second terminal portion having one or more signal contact pads. The first terminal portion and the second terminal portion are spaced apart from each other in the second direction. One or more terminal groups in the plurality of terminal groups of the first board connector are formed as power transmission terminals, and one or more further terminal groups in the plurality of terminal groups are formed as signal transmission terminals.

Optionally, when the electrical connector is fitted to the first board connector, the power contact pad of the first interface is connected to a corresponding contact portion of the power transmission terminal of the first board connector for power transmission between the electrical connector and the first board connector. The signal contact pad of the first interface is connected to a corresponding contact portion of the signal transmission terminal of the first board connector for signal transmission between the electrical connector and the first board connector.

Optionally, each of the first conductive elements of the first board connector may comprise a first mating end adjacent to the socket, a first tail end opposite to the first mating end, and one or more curved portions disposed between the first mating end and the first tail end. The pair of the first conductive elements may comprise a first contact portion and a second contact portion adjacent to the first mating end and protruding towards a second central axis of the board connector. The first contact portion and the second contact portion are exposed in the slot.

Optionally, each of the second conductive elements of the first board connector may comprise a second tail end flush with the first tail end of the first conductive element, a second mating end opposite to the second tail end, and one or more curved portions disposed between the second mating end and the second tail end. The pair of second conductive elements may comprise a third contact portion and a fourth contact portion, which are adjacent to the second mating end and protruding towards a second central axis of the board connector. The third contact portion and the fourth contact portion are exposed in the slot.

Optionally, the first interface may comprise a first interface side surface and a second interface side surface opposite to the first interface side surface in the third direction. Each of the power contact pad and the signal contact pad of the first interface may comprise a plurality of conductive pads exposed at the first interface side surface and the second interface side surface. The plurality of conductive pads comprise a first row of conductive pads and a second row of conductive pads both disposed along the second direction. The first row of conductive pads and the second row of conductive pads are spaced apart from each other in the first direction, and the second row of conductive pads are closer to a free end of the first interface than the first row of conductive pads.

Optionally, when the first interface of the electrical connector is fitted to the first board connector, the first contact portion and the second contact portion of each first conductive element are engaged with a corresponding conductive pad of the first row of conductive pads; and the third contact portion and the fourth contact portion of each second conductive element are engaged with a corresponding conductive pad in the second row of conductive pads.

Optionally, the first tail end of each first conductive element extends through a mounting end of the second housing and is electrically connected with a corresponding connecting conductive portion of the first circuit board. The second tail end of each second conductive element extends through the mounting end of the second housing and is electrically connected with a corresponding connecting conductive portion of the first circuit board.

Optionally, the electronic system may further comprise: a second circuit board, and a second board connector which is configured to be the same as the first board connector and which is connected to the second circuit board.

Optionally, the electrical connector is fitted to the second board connector such that the second interface of the electrical connector is inserted into a slot of the second board connector for board-to-board interconnection of the first circuit board with the second circuit board.

These techniques may be used alone or in any suitable combination. The foregoing summaries are provided by way of illustration and are not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a perspective view of an electrical connector, according to some embodiments.

FIG. 2 is a partially exploded perspective view of the electrical connector of FIG. 1.

FIG. 3 is a front view of the electrical connector of FIG. 1.

FIG. 4 is a side view of the electrical connector of FIG. 1.

FIG. 5 is cross-sectional view of the electrical connector of FIG. 1 along a line marked “E-E” in FIG. 4.

FIG. 6 is a perspective view of the electrical connector of FIG. 1, with a first housing hidden.

FIG. 7 is a front view of the electrical connector of FIG. 6.

FIG. 8 is a side view of the electrical connector of FIG. 6.

FIG. 9 is a perspective view of the electrical connector of FIG. 6, with elastic members hidden.

FIG. 10 is a perspective view of a board connector, according to some embodiments.

FIG. 11 is a perspective view of the board connector of FIG. 10, with a second housing hidden.

FIG. 12 is a perspective view of terminal groups of the board connector of FIG. 10.

FIG. 13 is a side view of one terminal group of FIG. 12.

FIG. 14 is a perspective view of an electronic system comprising the electrical connector of FIG. 1 and the board connector of FIG. 10, according to some embodiments.

FIG. 15 is a partially exploded perspective view of the electronic system of FIG. 14, with portions hidden and showing a first circuit board, interfaces of the electrical connector of FIG. 1, and terminal groups of the board connector of FIG. 10.

FIG. 16 is a perspective view of the electronic system of FIG. 15 in an engaged state.

FIG. 17 is a side view of a connecting member of an electronic system of FIG. 14.

FIG. 18 is cross-sectional view of the connecting member of FIG. 17 along a line marked “F-F” in FIG. 17.

FIG. 19 is a perspective view of an electronic system, according to some embodiments.

FIG. 20 is a partially exploded perspective view of the electronic system of FIG. 19.

FIG. 21 is a side view of the electronic system of FIG. 19.

FIG. 22 is cross-sectional view of the electronic system of FIG. 19 along a line marked “G-G” in FIG. 21.

### DETAILED DESCRIPTION

The inventors have recognized and appreciated connector design techniques for making connections between circuit boards, even if the circuit boards are misaligned in one or more dimensions. Such connectors may support signal or ground connections, and in some examples may provide both signal paths and power connections between circuit boards.

Conventionally, each of two circuit boards may have a connector mounted thereon, and electrical interconnections between the two circuit boards may be established through the direct coupling of these connectors. However, such a configuration may not sufficiently compensate for misalignments between the connectors, which can arise during manufacturing and assembly and/or during use. For example, intrinsic dimensional mismatches may occur during connector fabrication. Additionally, discrepancies in the footprints of connectors on different boards may result from board fabrication variances. Additionally, the mounting process of the connectors may introduce offsets. These misalignments can lead to increased signal distortion, electromagnetic interference, power discontinuity, and/or even system malfunction. Techniques described herein provide hybrid floating electrical connectors and electronic systems thereof, which may enable accurate and reliable interconnections between different circuit boards.

Accordingly to aspects of the present disclosure, a floating electrical connector may include a housing comprising first and second sides, and first and interfaces at the first and second sides of the housing respectively. Each of the first and second interfaces may include conductive elements. In some embodiments, each of the first and second interfaces may include a printed circuit board having one or more rows of contact pads connected to conductive traces embedded within the printed circuit board. In some embodiments, each of the first and second interfaces may be configured to provide both signal and power transmission. For example, each of the first and second interfaces may have a power terminal portion and a signal terminal portion, which may be spaced apart to reduce the risks of interference.

The floating connector may include a first support member at least partially disposed in the housing and compliantly coupled thereto. The first interface may be rigidly fixed to the first support member. In some embodiments, a first elastic member may be disposed between the first support member and the housing such that the first support member is movable with respect to the housing. In some embodiments, a second support member may be at least partially disposed in the housing and compliantly coupled to the housing. The second interface may be rigidly fixed to the second support member. In some embodiments, a second elastic member may be disposed between the second support member and the housing such that the second support member is movable with respect to the housing. For example, each of the first and second elastic members may comprise a silicone rubber gasket.

A flexible member may be disposed in the housing and electrically connect the first and second interfaces. The flexible member may electrically connect the conductive elements of the first and second interfaces. In some embodiments, the flexible member may comprise a cable such as a flexible flat cable (FFC) or another suitable cable type, such that the first and second mating interfaces are not rigidly connected to each other, thereby accommodating mechanical tolerances.

Accordingly to aspects of the present disclosure, an electrical connector may include a housing and a terminal assembly held by the housing. The terminal assembly may include terminal groups and an assembly housing holding the terminal groups. The housing may include channels for receiving the terminal groups of the terminal assembly, a mounting end configured to mount to a circuit board, a mating end, a slot having a socket at the mating end. The housing may include one or more projections protruding outwardly in directions perpendicular to a mating direction of the connector. Each projection may include an aperture extending therethrough and configured to receive a connecting member for securing the connector to the circuit board.

The terminal groups may be disposed side by side in a row direction perpendicular to the mating direction of the connector and spaced apart from each other. Each terminal group may include a pair of firs conductive elements facing each other in a column direction perpendicular to both the mating direction and the row direction, and a pair of second conductive elements facing each other in the column direction. The first conductive elements may extend further in the mating direction than the second conductive elements. Each projection may be shorter than the first conductive element in the mating direction.

In some embodiments, the floating connector may be configured to mate with board connectors mounted to different circuit boards. The first and second interfaces of the floating connector may be disposed in slots of respective board connectors. The first and second support members of the floating connector may be fixedly connected to respective board connector housings. The housing of the floating connector may be movable with respect to the board connector housings. Such a configuration can enable an electronic system to establish accurate and reliable interconnections between different circuit boards while providing increased tolerance of misalignments arising from manufacturing, assembly, and/or operational variations.

Next, exemplary embodiments of the present disclosure will be described in detail with reference to the accompanying drawings. For a clear and concise description, a three-dimensional coordinate system including a first direction Y, a second direction X, and a third direction Z may be labeled in the figures. The first direction Y, the second direction X, and the third direction Z may be perpendicular to one another. The first direction Y may refer to a mating direction of the electrical connector with a complementary mating component. The first direction Y may be referred to as a length direction of an electrical connector. The second direction X may be referred to as a width direction of the electrical connector.

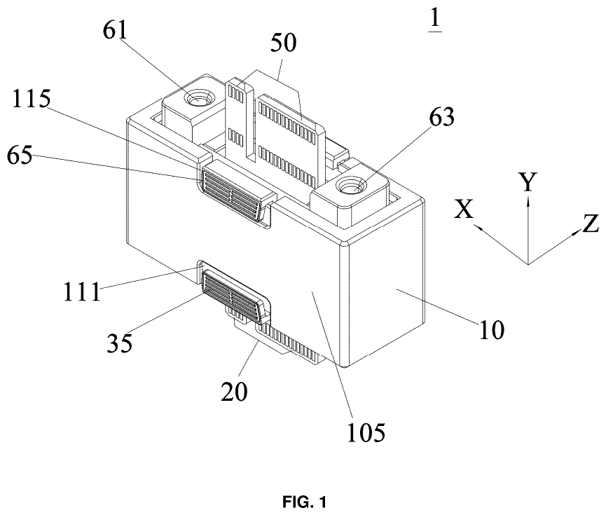

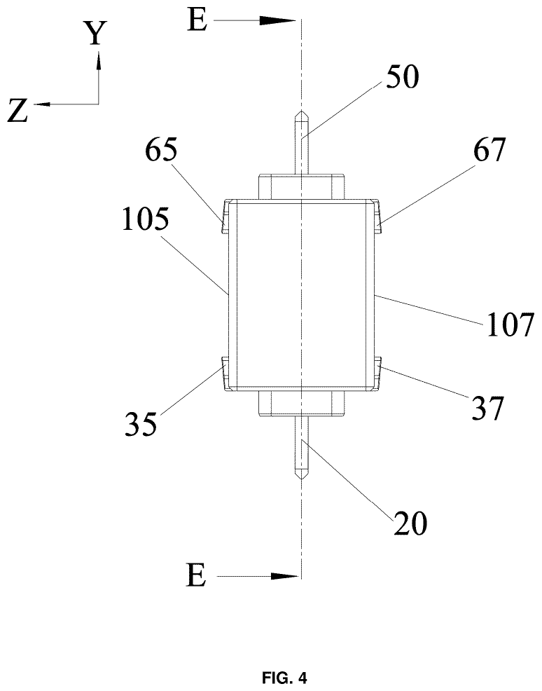

According to aspects of the present disclosure, as shown in FIGS. 1 to 5, an electrical connector 1 may comprise a first housing 10 having a first side 101 and a second side 102 opposite to the first side 101 in the first direction Y of the first housing; a first interface 20 at least partially disposed in the first housing 10, the first interface 20 comprising first conductive elements and extending beyond the first side 101 in the first direction; a first support member 30 at least partially disposed in the first housing 10 and positioned close to the first side 101, the first interface 20 configured to be fixedly connected to the first support member 30; and a first elastic member 40 disposed between an outer surface of the first support member 30 and an inner surface of the first housing 10. The first elastic member 40 is deformable to allow the first support member 30 to be deflected with respect to the first housing 10 in at least one of the second direction X and the third direction Z.

The electrical connector 1 may comprise a second interface 50 at least partially disposed in the first housing 10, the second interface 50 comprising second conductive elements and extending beyond the second side 102 in the first direction Y; and a flexible member 80 disposed between the first interface 20 and the second interface 50 and electrically connecting the first conductive elements of the first interface 20 with the second conductive elements of the second interface 50.

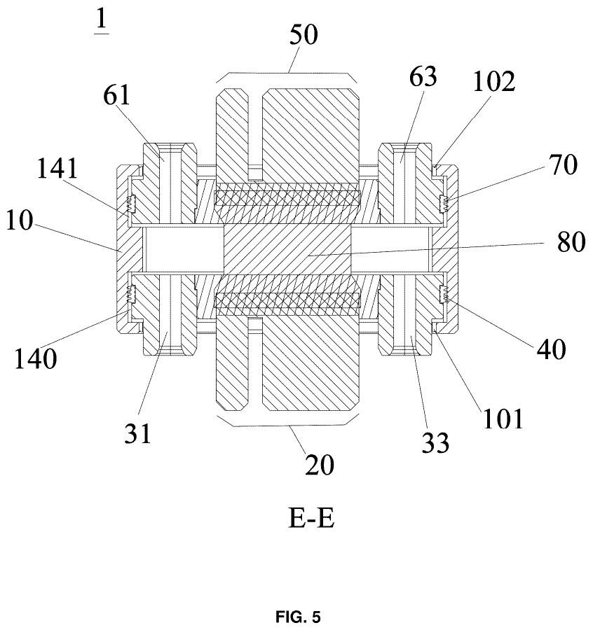

With the provision of the deformable first elastic member 40, the first support member 30, which is fixedly connected to the first interface 20, can be deflected (floated) by a certain amount with respect to the first housing 10 in at least one of the second direction X (the left-right direction as shown in FIG. 5) and the third direction Z. For Example, when the first interface 20 of the electrical connector 1 is inserted into the mating connector mated with the electrical connector 1, when there is a certain positional offset between the electrical connector 1 and the mating connector, the first elastic member 40 can automatically compensate for the position by an elastic deformation and still ensure that a good mechanical connection and an electrical connection between the electrical connector 1 and the mating connector are realized. The first elastic member realizes a flexible connection and has a certain positional compensation and buffering effect during the connection process, thereby improving the accuracy and smoothness of the connection between the electrical connector 1 and the mating connector, and at the same time prolonging the service life of the electrical connector. The electrical connector according to the present disclosure using a flexible connection method can be adapted to more complex installation environments than a conventional plug connector and a receptacle connector that require high-precision alignment for interconnection.

The flexible member 80 of the present disclosure may have good bending properties and flexibility, and may be less susceptible to damage, and can better withstand vibration and stress. The flexible member can provide compensation for positional offset between the first interface 20 and the second interface 50 in at least one of the first direction Y, the second direction X, and the third direction Z, thereby providing a reliable connection between the first interface 20 and the second interface 50 and a flexible layout design. This provides greater flexibility and reliability in the design and manufacture of the electrical connector.

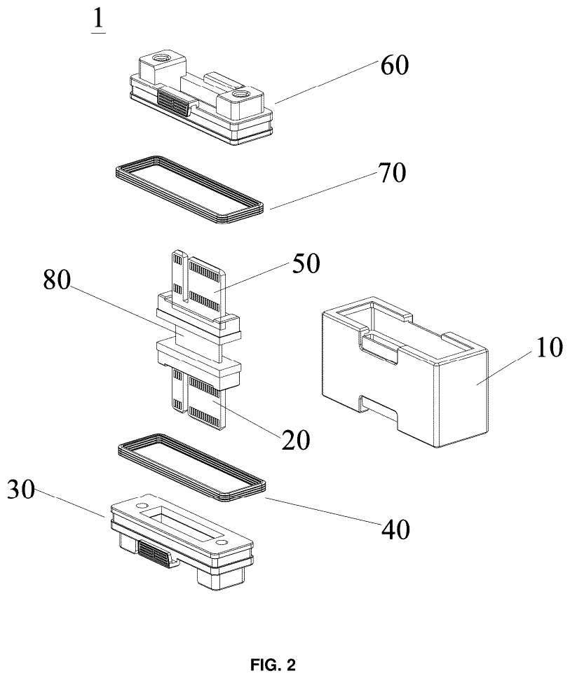

As shown in FIG. 2, the electrical connector 1 may comprise a second support member 60 at least partially disposed in the first housing 10 and positioned close to the second side 102, the second interface 50 configured to be fixedly connected to the second support member 60; and a second elastic member 70 disposed between an outer surface of the second support member 60 and an inner surface of the first housing 10. The second elastic member 70 is deformable to allow the second support member 60 to be deflected with respect to the first housing 10 in at least one of the second direction X and the third direction Z.

The second elastic member 70 disposed between an outer surface of the second support member 60 and an inner surface of the first housing 10 may perform substantially the same function as the first elastic member 40. The second elastic member 70 may allow the second support member 60, which is fixedly connected to the second interface 50, to be deflected (floated) by a certain amount with respect to the first housing 10 in at least one of the second direction X (the left-right direction as shown in FIG. 5) and the third direction Z. For Example, when the second interface 50 of the electrical connector 1 is inserted into the mating connector mated with the electrical connector 1, when there is a certain positional offset between the electrical connector 1 and the mating connector, the second elastic member 70 can automatically compensate for the position by an elastic deformation and still ensure that a good mechanical connection and an electrical connection between the electrical connector 1 and the mating connector are realized.

In some embodiments, the use of both the first elastic member 40 and the second elastic member 70 can compensate for the positional offset of the first interface 20 and the second interface 50 in at least one of the second direction X (the left-right direction as shown in FIG. 5) and the third direction Z, thereby realizing a flexible connection between the first interface 20 and the second interface 50 of the electrical connector 1, and between each of the first interface 20 and the second interface 50 and the corresponding connector, thereby improving the connection accuracy and smoothness between the electrical connector 1 and the mating connector.

The first support member 30 may comprise a hole extending through the first support member 30 along the first direction Y, and the second support member 60 may comprise a hole extending through the second support member 60 along the first direction Y.

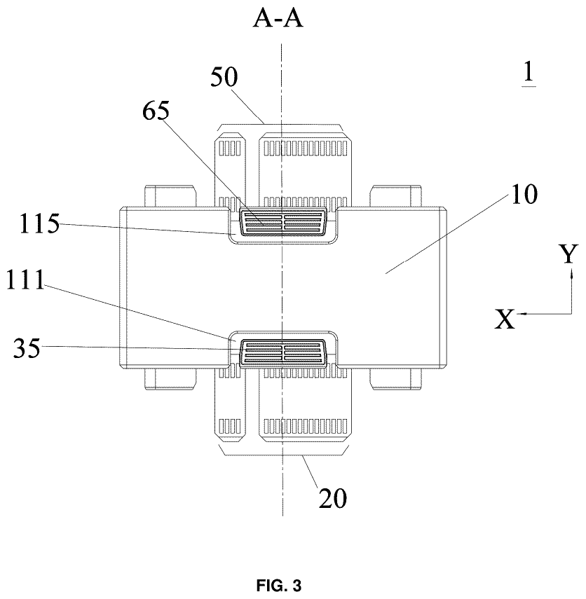

As shown in FIGS. 3 to 5, the first support member 30 may comprise a first hole 31 and a second hole 33, which are configured to be symmetrical about a first central axis A-A of the electrical connector. The second support member 60 may comprise a third hole 61 and a fourth hole 63, which are configured to be symmetrical about the first center axis A-A of the electrical connector. The first hole 31 is aligned with the third hole 61 in the first direction Y of the electrical connector; and the second hole 33 is aligned with the fourth hole 63 in the first direction Y of the electrical connector. It should be appreciated that the first center axis A-A may be the center axis in the front view of the electrical connector 1 (shown in FIG. 3) that bisects the electrical connector 1 in half along the first direction Y.

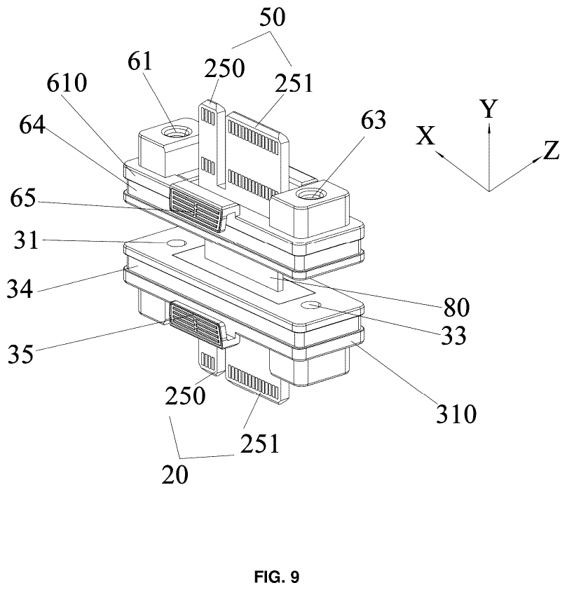

In some embodiments, as show in FIG. 9, the first support member 30 may comprise a first body portion 310 disposed in the first housing 10. The first body portion may comprise a first annular groove 34 on an outer peripheral surface. The first elastic member 40 may be disposed in the first annular groove 34. The second support member 60 may comprise a second body portion 610 disposed in the first housing 10. The second body portion may comprise a second annular groove 64 on an outer peripheral surface. The second elastic member 70 may be disposed in the second annular groove 64.

Optionally, each of the first elastic member 40 and the second elastic member 70 is formed as an annular member surrounding a corresponding support member. At least a portion of the annular member is disposed in the corresponding annular groove, and another portion of the annular member extends to protrude to an outer side of the corresponding annular groove. Each of the first elastic member 40 and the second elastic member 70 may be elastically deformable with respect to the first housing 10 in at least one of the second direction X and the third direction Z.

In some embodiments, each of the first support member 30 and the second support member 60 may comprise an engagement portion that engages with an outer surface of the first housing 10 to limit movement of the first housing 10 in the first direction Y.

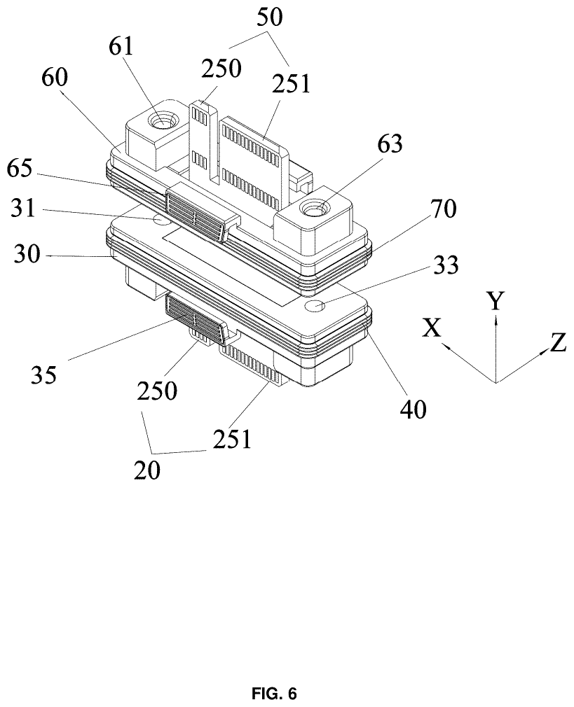

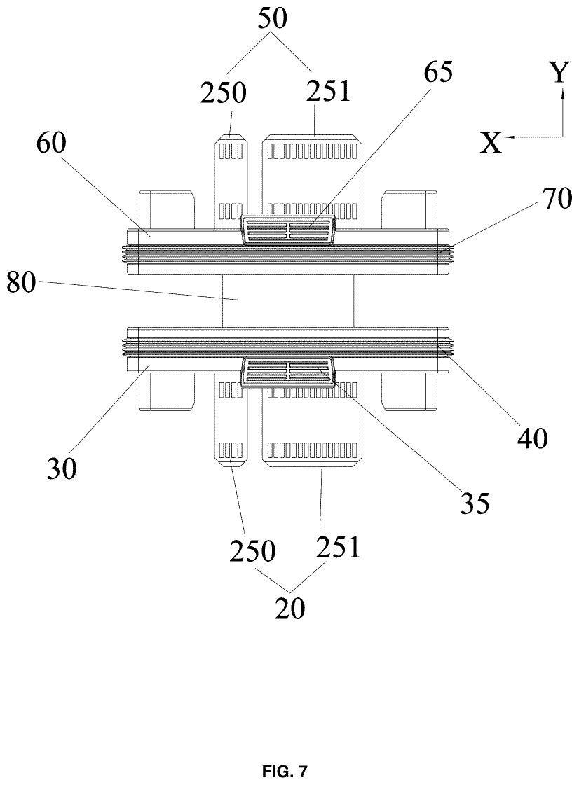

In some embodiments, the first support member 30 is formed as a profiled member. The first support member 30 may comprise a first inner surface adjacent to the flexible member 80 and a first outer surface opposite to the first inner surface in the first direction Y. As shown in FIGS. 6 to 9, the first support member 30 may comprise a first engagement portion 35 and a second engagement portion 37 which are disposed on two opposite lateral edges of the first outer surface in the third direction Z.

As shown in FIGS. 1 to 4, the first housing 10 may comprise a first housing side surface 105 and a second housing side surface 107 opposite to the first housing side surface 105 in the third direction Z. As shown in FIG. 3, the first housing side surface 105 may comprise a first recess 111 and a second recess 115, and the second housing side surface 107 may comprise a third recess and a fourth recess. The first hook 35 is engaged with the first recess 111 of the first housing side surface; and the second hook 37 is engaged with the third recess of the second housing side surface. Optionally, each of the first hook 35 and the second hook 37 may be formed as a snap portion engaged with a corresponding recess.

In some embodiments, the second support member 60 may be formed as a profiled member. The second support member 60 may comprise a second inner surface adjacent to the flexible member 80 and a second outer surface opposite to the second inner surface in the first direction Y. The second support member 60 may comprise a third hook 65 and a fourth hook 67, which are disposed on two opposite lateral edges of the second outer surface in the third direction Z.

As shown in FIG. 3, the third hook 65 may be engaged with the second recess 115 of the first housing side surface 105; and the fourth hook 67 is engaged with the fourth recess of the second housing side surface 107.

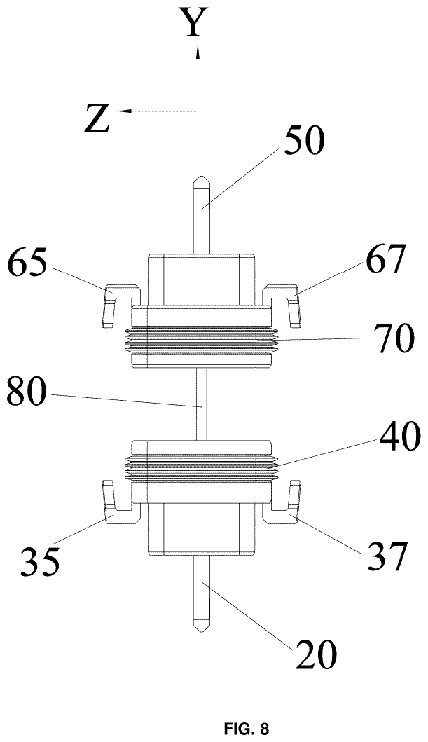

In some embodiments, as shown in FIG. 8, each of the first hook 35, the second hook 37, the third hook 65 and the fourth hook 67 may have a U-shaped cross-section perpendicular to the second direction X. The U-shape may be configured to open towards the flexible member 80. As shown in FIGS. 1 to 3, two opposite lateral edges of the first housing side surface 105 of the first housing 10 in the first direction Y may be clamped between the first hook 35 and the third hook 65. Two opposite lateral edges of the second housing side surface 107 of the first housing 10 in the first direction Y may be clamped between the second hook 37 and the fourth hook 67 to limit movement of the first housing 10 in the first direction Y and the third direction Z.

In some embodiments, the first interface 20 may be disposed in the second direction X between the first hole 31 and the second hole 33. The second interface 50 is disposed in the second direction X between the third hole 61 and fourth hole 63.

In some embodiments, as shown in FIG. 5, the first housing 10 may comprise a first chamber 140 and a second chamber 141 disposed on an inner periphery of the first housing. The first support member 30 is disposed in the first chamber, the second support member 60 is disposed in the second chamber. The first chamber 140 and the second chamber 141 are each formed to have a concave shape and are spaced apart from each other in the first direction Y of the electrical connector.

Optionally, a step is disposed on the inner periphery of the first housing 10 between the first chamber 140 and the second chamber 141. The step protrudes radially inwardly from the inner periphery of the first housing 10 to space the first support member 30 apart from the second support member 60.

In some embodiments, as shown in FIGS. 2 to 7, each of the first interface 20 and the second interface 50 is configured as a printed circuit board, and may comprise a first terminal portion 250 having one or more power contact pads, and a second terminal portion 251 having one or more signal contact pads. The first terminal portion 250 and the second terminal portion 251 are spaced apart from each other in the second direction X.

Optionally, at least one of the first elastic member 40 and the second elastic member 70 may comprise a silicone rubber gasket. Optionally, at least one of the first elastic member 40 and the second elastic member 70 may be formed from one of: silicone rubber, fluoroelastomer, butyl rubber, polytetrafluoroethylene, propylene-based elastomers, and the like.

Optionally, the flexible member 80 may be a cable, such as a Flexible Flat Cable (FFC) or a Flexible Printed Circuit. Optionally, the flexible member 80 may also be a cable that includes a plurality of wires. In some embodiments, the flexible member 80 is connected to the first interface 20 and the second interface 50 by, for example, the hot bar process (pulse-heated reflow soldering). Optionally, the flexible member 80 is connected to the first interface 20 and the second interface 50 by a hot bar process. For example, the flexible member 80 is connected to the first interface 20 and the second interface 50 via a pulsed heated reflow soldering process.

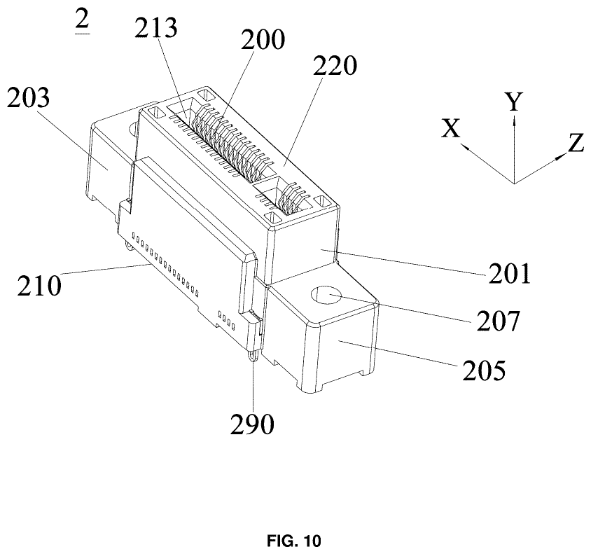

According to aspects of the present disclosure, as shown in FIG. 10, a board connector 2 may be configured as a receptacle connector. The board connector 2 may be configured to mount to a circuit board. The board connector 2 has a height extending along a first direction Y, a width extending along a second direction X perpendicular to the first direction Y, and a thickness extending along a third direction Z perpendicular to both the first direction Y and the second direction X.

As shown in FIG. 10, the board connector 2 may comprise: a terminal assembly 200 comprising a plurality of terminal groups and an assembly housing that holds the plurality of terminal groups and is molded over the plurality of terminal groups; and a second housing 201 comprising a plurality of channels for receiving the terminal assembly, the second housing 201 comprising a mounting end 210 to be mounted with a circuit board and a mating end 220 opposite to the mounting end. The second housing 201 comprises a slot 213, and a socket of the slot is disposed at the mating end of the second housing 201.

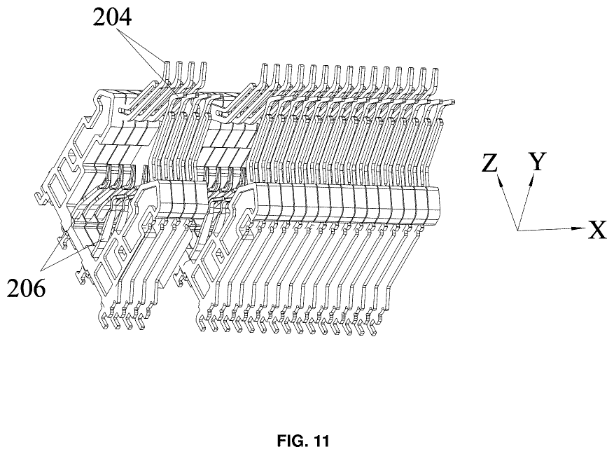

As shown in FIGS. 11 to 13, the plurality of terminal groups may be disposed side by side in the second direction X and spaced apart from each other. Each of the plurality of terminal groups may comprise a pair of first conductive elements 204 facing each other in the third direction Z, and a pair of second conductive elements 206 facing each other in the third direction Z. A size of the first conductive element 204 in the first direction Y is greater than a size of the second conductive element 206 in the first direction Y. A mating end of the first conductive element 204 is formed at the socket of the slot. Optionally, each of the plurality of terminal groups may be the same.

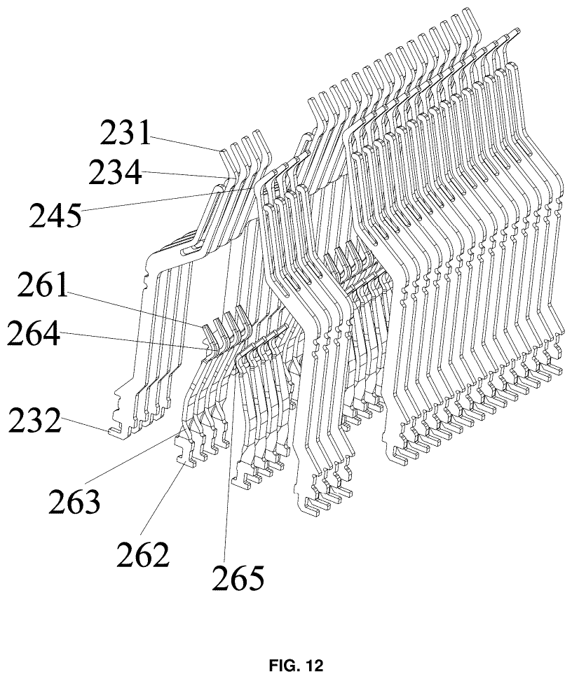

In an exemplary embodiment as shown in FIG. 12 of the present disclosure, four of the plurality of terminal groups are formed as power transmission terminals and the rest of the plurality of terminal groups are formed as signal transmission terminals.

It should be understood that the number and arrangement of the power transmission terminal and the signal transmission terminal are not limited to the exemplary embodiments described herein, but may be adjusted as actually needed.

In some embodiments, as shown in FIG. 10, the second housing 201 may comprise a first projection 203 and a second projection 205 disposed on two opposite sides of the second housing 201 in the second direction X. A size of each of the first projection 203 and the second projection 205 in the first direction Y is smaller than a size of the first conductive element in the first direction Y. Each of the first projection 203 and the second projection 205 comprises an aperture 207. In the case where the board connector 2 is connected to the circuit board by a connecting member, the connecting member will extend through the aperture.

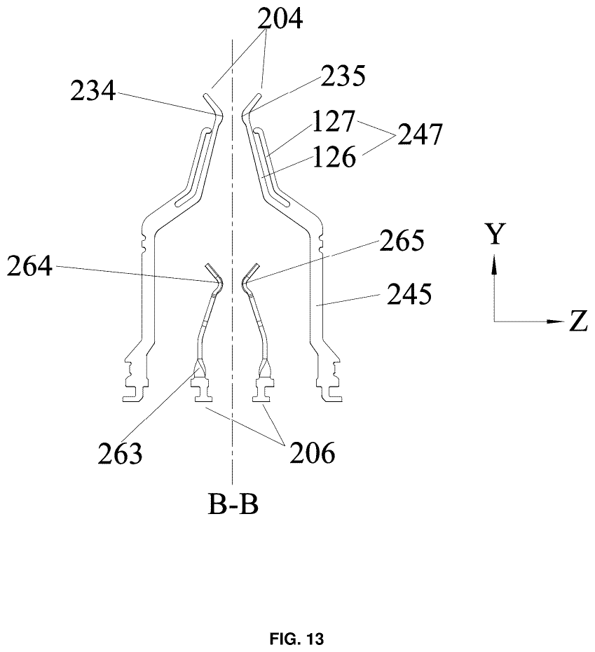

In some embodiments, as shown in FIGS. 12 and 13, each of the first conductive elements 204 may comprise a first mating end 231 adjacent to the socket, a first tail end 232 opposite to the first mating end, and one or more curved portions disposed between the first mating end and the first tail end. The pair of the first conductive elements comprise a first contact portion 234 and a second contact portion 235 adjacent to the first mating end and protruding towards a second central axis B-B of the board connector. The first contact portion and the second contact portion are exposed in the slot 213.

Each of the second conductive elements 206 may comprise a second tail end 262 flush with the first tail end 232 of the first conductive element, a second mating end 261 opposite to the second tail end, and one or more curved portions disposed between the second mating end and the second tail end. The pair of second conductive elements 206 may comprise a third contact portion 264 and a fourth contact portion 265 which are adjacent to the second mating end 261 and protrude towards a second central axis B-B of the board connector. The third contact portion and the fourth contact portion are exposed in the slot 213.

It should be understood that the second center axis B-B is the center axis in the side view of the board connector 2 (shown in FIG. 13) that bisects the board connector 2 in half along the first direction Y. It is to be understood that the expression “mating end” as used in the description of the present disclosure refers to an end adjacent to the mating end of the board connector, whereas the expression “tail end” refers to an end opposite to the mating end that is remote from the mating end of the board connector.

In some embodiments, the pair of first conductive elements 204 may be mirrored about the second central axis B-B of the board connector 2. The pair of second conductive elements 206 may be mirrored about the second central axis B-B of the board connector.

In some embodiments, a distance between the first contact portion 234 of the first conductive element 204 and the third contact portion 264 of the second conductive element 206 in the first direction Y is in the range of 6 mm to 9 mm. The provision of the distance between the first contact portion and the third contact portion for transmitting signals within the above range ensures the desired signal integrity performance, whereby large product structures caused by an excessive spacing or large signal crosstalk caused by too small spacing can be avoided.

For example, in some embodiments, a distance between the first contact portion 234 and the third contact portion 264 in the first direction Y may be in the range of 7 mm to 8.5 mm. The provision of the distance between the first contact portion 234 and the third contact portion 264 in the range of 7 mm to 8.5 mm can balance signal transmission quality and product size. Optionally, a distance between the first contact portion 234 and the third contact portion 264 may be 6 mm, 7 mm, 8 mm or 8.5 mm.

In some embodiments, the first tail end 232 of each first conductive element 204 extends through a mounting end 210 of the second housing 201 and has an L-shaped shape in a cross-section perpendicular to the second direction X (as shown in FIGS. 12 and 13). The second tail end 262 of each second conductive element 206 extends through the mounting end 210 of the second housing 201 and has a T-shaped shape in a cross-section perpendicular to the second direction X (as shown in FIGS. 12 and 13).

It should be understood that the shape of the first tail end of the first conductive element 204 and the second tail end of the second conductive element 206 are not limited to the exemplary embodiments described herein, but may be adjusted according to actual circumstances.

In some embodiments, each of the second conductive elements 206 may comprise a twist 263 disposed between the second mating end 262 and the second tail end 261. The twist 263 connects a first belt portion and a second belt portion disposed at two opposite ends of the twist 263 such that a normal direction of a main surface of the first belt portion forms a twist angle in the range of 0 to 90 degrees with respect to a normal direction of a main surface of the second belt portion. The twist 263 reduces the rigidity of the second conductive element, which in turn reduces the insertion force and retention force of the board connector 2.

The provision of the twist angle in the range of 0 to 90 degrees allows the contact portion (contact surface portion) of the second conductive element 206, which is located above the twist 263 in the first direction Y, to form a line contact as much as possible with a connector (e.g., a card) to be inserted into the slot, in order to ensure the quality of transmission. A point contact (due to too large or too small twist angle) between the contact surface of the contact portion and the corresponding connector (e.g., card) is thereby prevented, as the point contact may affect the transmission quality.

Optionally, the twist angle of the twist may be about 45 degrees, about 80 degrees, about 90 degrees. In some embodiments, each of the first conductive element 204 and the second conductive element 206 may comprise a corresponding twist.

In some embodiments, as shown in FIG. 13, each first conductive element 204 may comprise a support arm 245 and an elastic arm 247 disposed between the first mating end 231 and the first tail end 232. The support arm 245 is adjacent to the first tail end 232 and connected to the elastic arm 247, and each of the first contact portion 234 and the second contact portion 235 is disposed on the elastic arm 247. The elastic arm 247 is inclined relative to the support arm 245.

The elastic arm 247 may comprise a primary elastic arm 126 and a secondary elastic arm 127; the primary elastic arm 126 and the secondary elastic arm 127 both extend from a position where the elastic arm 247 is connected to the support arm 245 in a direction away from the support arm 245, and the primary elastic arm 126 and the secondary elastic arm 127 are spaced apart from each other. Each of the first contact portion 234 and the second contact portion 235 is disposed on a side of the primary elastic arm 126 facing away from the secondary elastic arm 127. Optionally, the primary elastic arm 126 has a length greater than a length of the secondary elastic arm 127.

In some embodiments, either or both of the first conductive element 204 and the second conductive element 206 may include a primary elastic arm and a secondary elastic arm which may be shaped so as to provide a desired insertion force or retention force for corresponding contact portions of the first conductive element 204 and the second conductive element 206.

The elastic arms of the first conductive element 204 are designed as two separate portions, e.g., the primary elastic arm 126 and the secondary elastic arm 127. In this manner, the resistance generated by the contact portion of the first conductive element can be reduced when the mating connector (e.g., card) is inserted into the slot of the board connector. The user can easily perform the insertion. A gap exists between the primary elastic arm 126 and the secondary elastic arm 127. The end where the primary elastic arm 126 and the secondary elastic arm 127 are connected is relatively fixed, and the respective free ends of the primary elastic arm 126 and the secondary elastic arm 127 are independent of each other. When the contact portion disposed on the primary elastic arm 126 is mated with the corresponding conductive pad of the mating connector, the primary elastic arm 126 and the secondary elastic arm 127 elastically deform, which can effectively absorb a certain amount of impact force, and thus prolong the service life of the board connector 2.

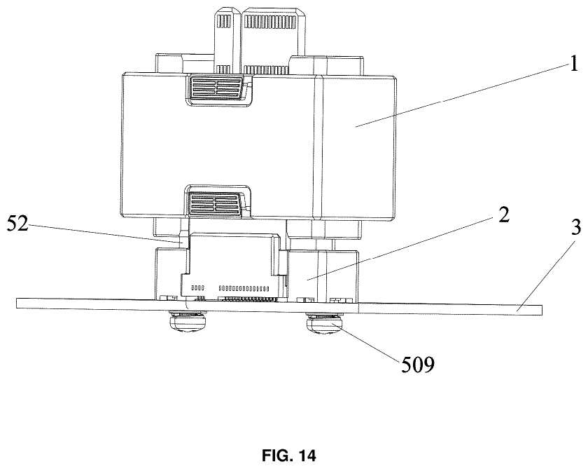

According to aspects of the present disclosure, as shown in FIG. 14, the electronic system 100 may comprise a first circuit board 3; a first board connector 2 which is the board connector of claim 1 and which is connected to the first circuit board by a connecting member 5; and an electrical connector 1 which is the electrical connector according to the present disclosure stated above and which is fitted to the first board connector such that the first interface 20 of the electrical connector is inserted into a slot 213 of the first board connector.

As discussed above, the second housing 201 of the first board connector 2 may comprise a first projection 203 and a second projection 205 disposed on two opposite sides of the second housing 201 in the second direction X. A size of each of the first projection 203 and the second projection 205 in the first direction Y is smaller than a size of the first conductive element 104 in the first direction Y. Each of the first projection 203 and the second projection 205 comprises an aperture 207 (as shown in FIG. 10). The first support member 30 may comprise a hole 31, 33 extending through the first support member 30 along the first direction Y.

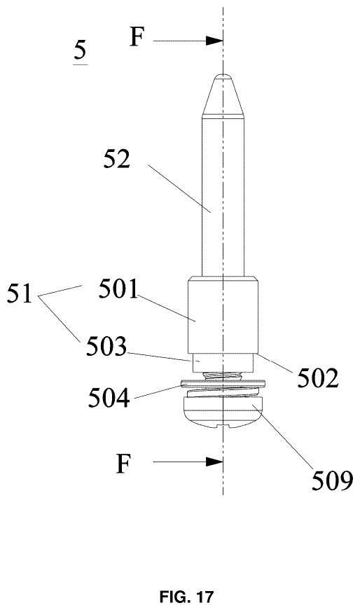

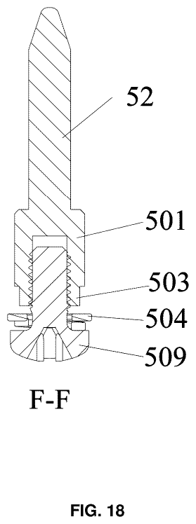

As shown in FIGS. 17 and 18, the connecting member 5 may comprise a locking portion 51 and a guiding portion 52 connected to the locking portion 51, the guiding portion 52 extending along the first direction Y. The first board connector 2 is fixedly connected to the first circuit board by the locking portion 51.

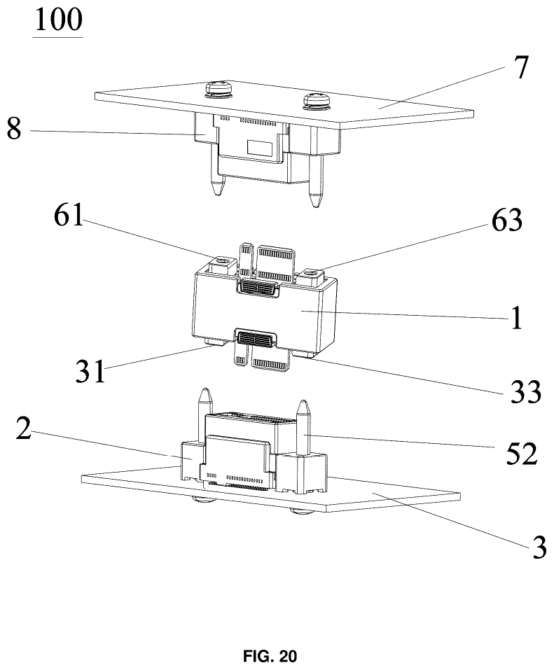

As shown in FIG. 20, the guiding portion 52 extends through the aperture of the second housing 201 and extends beyond the mating end 220 of the second housing 201. The guiding portion 52 may be inserted into the hole of the first support member 30 of the electrical connector, when the electrical connector 1 is fitted to the first board connector 2.

As shown in FIGS. 17 and 18, the locking portion 51 may comprise a first cylindrical portion 501 connected to the guiding portion and a second cylindrical portion 503 having a diameter smaller than a diameter of the first cylindrical portion. A first stop surface 502 is formed at a connection surface where the first cylindrical portion is combined with the second cylindrical portion. The connecting member 5 may comprise a second stop surface 504 spaced apart from the first stop surface in the first direction Y.

An end of the locking portion 51 opposite to the guiding portion may comprise a hollow cavity having an inner threaded portion. The first circuit board 3 is clamped between the first stop surface 502 and the second stop surface 504 when a screw 509 is inserted into the hollow cavity and engaged with the inner threaded portion. A firm connection of the first board connector 2 to the first circuit board 3 can be realized by the screw, and such a threaded connection mode is not easy to be loosened and has good vibration resistance. It is able to withstand large tensile and shear forces, and is easy to disassemble for easy care and maintenance.

The guiding portion 52 of the connecting member 5 may be formed as a guiding post with high strength to guide the insertion of the electrical connector 1, and may support the blind insertion of the electrical connector 1, which reduces the assembling time, reduces the assembling error and the cost of the mounting, and thus improves the assembling efficiency, and at the same time, improves the convenience of the assembling.

In some embodiments, the guiding portion 52 is connected with the hole 31, 33 of the first support member 30 of the electrical connector in a clearance fit manner, when the electrical connector 1 is fitted to the first board connector 2.

In some embodiments, the first interface 20 may comprise a first terminal portion 250 having one or more power contact pads, and a second terminal portion 251 having one or more signal contact pads. The first terminal portion and the second terminal portion are spaced apart from each other in the second direction X.

One or more of the plurality of terminal groups of the first board connector 2 may be formed as power transmission terminals. One or more further terminal groups in the plurality of terminal groups may be formed as signal transmission terminals.

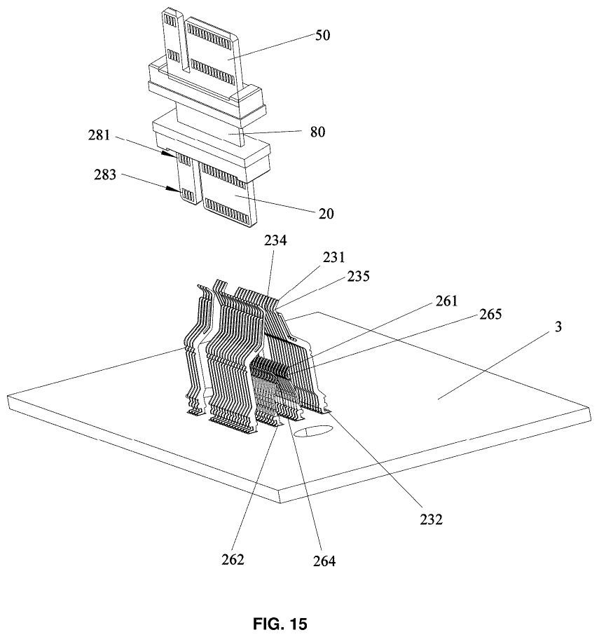

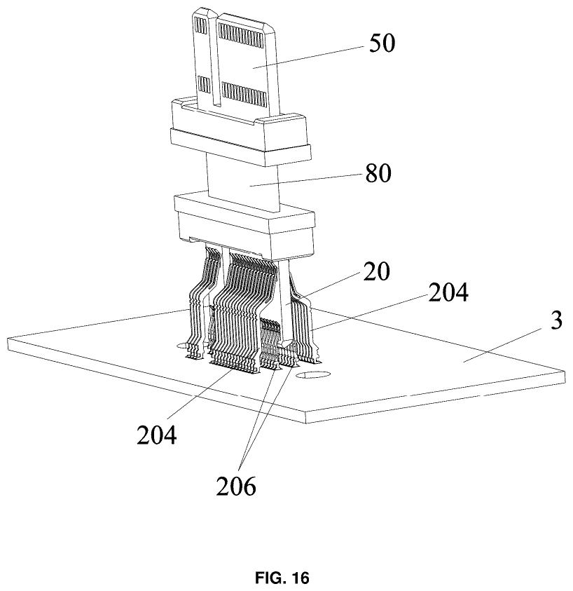

As shown in FIGS. 15 and 16, when the electrical connector 1 is fitted to the first board connector 2, the power contact pad of the first interface 20 is connected to a corresponding contact portion of the power transmission terminal of the first board connector for power transmission between the electrical connector 1 and the first board connector 2, and the signal contact pad of the first interface 20 is connected to a corresponding contact portion of the signal transmission terminal of the first board connector 2 for signal transmission between the electrical connector 1 and the first board connector. In this way, it is possible to provide a reliable power transmission path and a high-quality signal transmission path between the electrical connector 1 and the first board connector 2, thereby adapting to the needs of a wider range of electronic communication systems.

In some embodiments, each of the first conductive elements of the first board connector 2 may comprise a first mating end 231 adjacent to the socket, a first tail end 232 opposite to the first mating end, and one or more curved portions disposed between the first mating end and the first tail end. The pair of first conductive elements 204 comprise a first contact portion 234 and a second contact portion 235 which are adjacent to the first mating end 231 and protruding towards a second central axis B-B of the board connector. The first contact portion 234 and the second contact portion 235 are exposed in the slot 213.

Each of the second conductive elements 206 of the first board connector may comprise a second tail end 262 flush with the first tail end 232 of the first conductive element, a second mating end 261 opposite to the second tail end, and one or more curved portions disposed between the second mating end and the second tail end. The pair of second conductive elements comprise a third contact portion 264 and a fourth contact portion 265, which are adjacent to the second mating end 262 and protruding towards a second central axis B-B of the board connector. The third contact portion 264 and the fourth contact portion 265 are exposed in the slot 213.

The first interface 20 may comprise a first interface side surface and a second interface side surface opposite to the first interface side surface in the third direction Z; each of the power contact pad and the signal contact pad of the first interface 20 may comprise a plurality of conductive pads exposed at the first interface side surface and the second interface side surface. As shown in FIG. 15, the plurality of conductive pads of the first interface 20 comprise a first row of conductive pads 281 and a second row of conductive pads 283 both disposed along the second direction X, the first row of conductive pads and the second row of conductive pads configured to be spaced apart from each other in the first direction Y. The second row of conductive pads 283 is closer to a free end of the first interface 20 than the first row of conductive pads 281.

It should be understood that the number and arrangement of the conductive pad of each of the power contact pad and the signal contact pad of the first interface 20 are not limited to the exemplary embodiments described herein, but may be adjusted as actually needed.

As shown in FIG. 16, the first contact portion 234 and the second contact portion 235 of each first conductive element are engaged with a corresponding conductive pad of the first row of conductive pads 281 when the first interface 20 of the electrical connector 1 is fitted to the first board connector 2. The third contact portion 264 and the fourth contact portion 265 of each second conductive element are engaged with a corresponding conductive pad in the second row of conductive pads 283.

In some embodiments, the first tail end 232 of each first conductive element 204 extends through a mounting end 210 of the second housing 201 and is electrically connected with a corresponding connecting conductive portion of the first circuit board 3. The second tail end of each second conductive element 206 extends through the mounting end 210 of the second housing 201 and is electrically connected with a corresponding connecting conductive portion of the first circuit board 3. In some embodiments, the first board connector 2 includes a plurality of retention members 290 (shown in FIG. 10) that are inserted into the circuit board. the retention members 290 are, for example, retention clips.

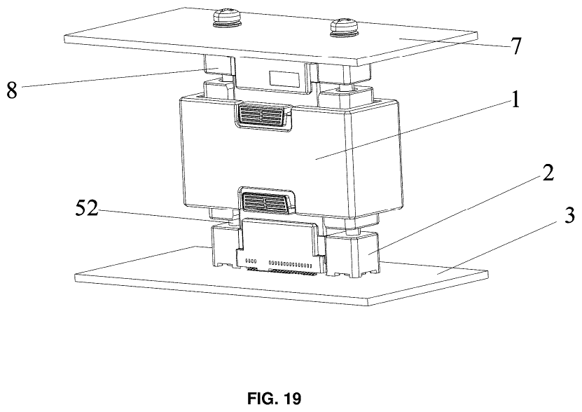

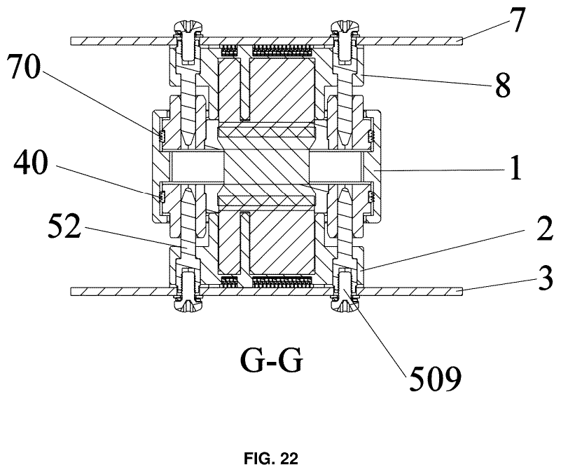

As shown in FIGS. 19 and 22, the electronic system 100 may further comprise a second circuit board 7, and a second board connector 8 which is configured to be the same as the first board connector 2 and which is connected to the second circuit board 7.

The electrical connector 1 is fitted to the second board connector 8 such that the second interface 50 of the electrical connector 1 is inserted into a slot of the second board connector 8 for board-to-board interconnection of the first circuit board 3 with the second circuit board 7.

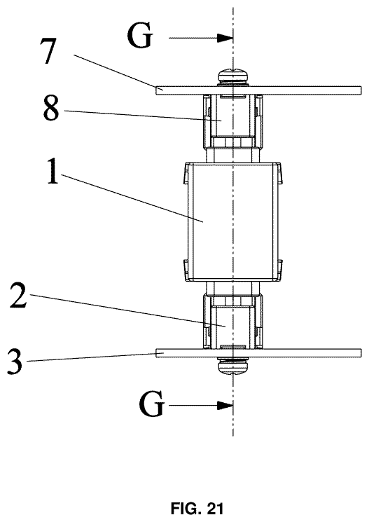

As shown in FIGS. 20 to 22, when the first interface 20 of the electrical connector 1 is inserted into the first board connector 2 and the second interface 50 of the electrical connector 1 is inserted into the second board connector 8, if there is a certain position offset between the electrical connector 1 and the first board connector 2 and/or the second board connector 8, the first elastic member 40 and the second elastic member 70 can automatically compensate for the position through elastic deformation, and it is still ensured that a good mechanical and electrical connection of the electrical connector 1 with the first board connector 2 and the second board connector 8, respectively, is realized. For Example, both the first elastic member 40 and the second elastic member 70 may be deflected (floated) with respect to the first housing 10 in at least one of the second direction X and the third direction Z, and can realize a flexible connection and have a certain positional compensation and buffering effect during the connection process, thereby improving the accuracy and smoothness of the connection between the electrical connector 1 and the two mating board connectors, and at the same time prolonging the service life of the electrical connector 1. The electronic system according to the present disclosure using a flexible connection method can be adapted to more complex installation environments than a conventional plug connector and a receptacle connector that require high-precision alignment for interconnection.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to vertical connectors, it should be understood that the aspects of the present disclosure are not limited to vertical connectors. Any one of the creative features, whether alone or combined with one or more other creative features, can also be used for other types of electrical connectors, such as right angle connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front”, “rear”, “upper”, “lower”, “left”, “right”, “transverse direction”, “vertical direction”, “perpendicular”, “horizontal”, “top”, “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation.

It should be noted that the terms used herein are for describing specific embodiments, and are not intended to limit the exemplary embodiments according to the present disclosure. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a housing comprising a first side and a second side;
a support member at least partially disposed in the housing and movably coupled to the housing;
a first interface at the first side of the housing, the first interface comprising a plurality of first conductive elements fixed to the support member;
a second interface at the second side of the housing, the second interface comprising a plurality of second conductive elements; and
a flexible member disposed in the housing and electrically connecting respective first conductive elements of the first interface with respective second conductive elements of the second interface.

2. The electrical connector of claim 1, comprising:
an elastic member disposed between the support member and the housing.

3. The electrical connector of claim 2, wherein:
the support member is a first support member;
the electrical connector comprises a second support member at least partially disposed in the housing and compliantly coupled to the housing; and
the plurality of second conductive elements are rigidly fixed to the second support member.

4. The electrical connector of claim 3, wherein:
the elastic member is a first elastic member; and
the electrical connector comprises a second elastic member disposed between the second support member and the housing.

5. The electrical connector of claim 4, wherein:
the first support member comprises first and second holes extending through the first support member;
the second support member comprises third and fourth holes extending through the second support member;
the first hole is aligned with the third hole in a mating direction of the electrical connector; and
the second hole is aligned with the fourth hole in the mating direction.

6. The electrical connector of claim 4, wherein:
the first support member comprises a first body portion disposed in the housing and a first annular groove;
the first elastic member is disposed in the first annular groove;
the second support member comprises a second body portion disposed in the housing and having a second annular groove; and
the second elastic member is disposed in the second annular groove.

7. The electrical connector of claim 4, wherein:
each of the first support member and the second support member comprises a hook engaging an outer surface of the housing.

8. The electrical connector of claim 7, wherein:
the hook comprises a U-shaped cross-section that opens toward the flexible member.

9. The electrical connector of claim 5, wherein:
the first interface is disposed between the first hole and the second hole of the first support member; and
the second interface is disposed between the third hole and fourth hole of the second support member.

10. The electrical connector of claim 5, wherein:
the housing comprises a first chamber and a second chamber;
the first support member is disposed in the first chamber; and
the second support member is disposed in the second chamber and spaced from the first chamber in the mating direction.

11. The electrical connector of claim 1, wherein:
the first interface comprises a printed circuit board; and
the printed circuit board comprises a first terminal portion having one or more power contact pads, and a second terminal portion spaced from the first terminal portion and having one or more signal contact pads.

12. The electrical connector of claim 2, wherein:
the elastic member comprises a silicone rubber gasket.

13. The electrical connector of claim 1, wherein:
the flexible member comprises a cable connected to both the first interface and the second interface.

14. The electrical connector of claim 13, wherein:
the cable is a flexible flat cable.

15. An electrical connector comprising:
a terminal assembly comprising a plurality of terminal groups and an assembly housing holding the plurality of terminal groups; and
a housing comprising a plurality of channels for receiving the plurality of terminal groups of the terminal assembly, a mounting end configured to mount to a circuit board, a mating end, a slot having a socket at the mating end, and a projection protruding in a second direction perpendicular to a mating direction of the connector and comprising an aperture extending through the projection, the aperture configured to receive a connecting member for securing the connector to the circuit board.

16. The electrical connector of claim 15, wherein:
the plurality of terminal groups are disposed side by side in the second direction and spaced apart from each other;
each of the plurality of terminal groups comprises a pair of first conductive elements facing each other in a third direction perpendicular to both the mating direction and the second direction, and a pair of second conductive elements facing each other in the third direction; and
the first conductive elements is longer than the second conductive element in the mating direction.

17. The electrical connector of claim 16, wherein:
the projection is a first projection protruding from a first side of the housing;
the housing comprises a second projection protruding from a second side of the housing and comprising an aperture extending through the second projection; and
each of the first projection and the second projection is shorter than the first conductive elements in the mating direction.

18. An electronic system, comprising:
a circuit board;
a first electrical connector mounted to the circuit board, the first electrical connector comprising a first housing having a slot at a mating end facing away from the circuit board; and
a second electrical connector comprising a support member fixedly connected to the first housing of the first electrical connector, a mating interface rigidly fixed to the support member and disposed in the slot of the first housing of the first electrical connector, and a second housing holding the support member and compliantly coupled to the support member such that the second housing is movable with respect to the first housing of the first electrical connector.

19. The electronic system of claim 18, wherein:
the support member of the second electrical connector is a first support member;
the mating interface of the second electrical connector is a first mating interface; and
the second electrical connector comprises a second mating interface, and a flexible member disposed in the second housing and electrically connecting respective conductive elements of the first electrical connector with respective second conductive elements of the second interface of the second electrical connector.

20. The electronic system of claim 19, wherein:
the circuit board is a first circuit board;
the electronic system comprises:
a second circuit board, and
a third electrical connector mounted to the second circuit board, the third electrical connector comprising a third housing fixedly connected to the second support member of the second electrical connector;
the second interface of the second electrical connector is disposed in the third housing of the third electrical connector; and
the second electrical connector comprises a second support member compliantly coupled to the second housing of the second electrical connector such that the second housing of the second electrical connector is movably with respect to the third housing of the third electrical connector.
